(19) United States
(12) Patent Application Publication
(10) Pub. No.: US 2024/0221275 A1
(43) Pub. Date: Jul. 4, 2024

(54) INFORMATION PROCESSING APPARATUS, INFORMATION PROCESSING METHOD, AND STORAGE MEDIUM

(71) Applicant: SONY GROUP CORPORATION, TOKYO (JP)

(72) Inventors: GAKU NARITA, TOKYO (JP); TOMOYA ISHIKAWA, TOKYO (JP); TAKASHI SENO, TOKYO (JP)

(21) Appl. No.: 18/556,290

(22) PCT Filed: Mar. 28, 2022
(86) PCT No.: PCT/JP2022/015015

§ 371 Date: Oct. 19, 2023

(30) Foreign Application Priority Data
May 11, 2021 (JP) 2021-080305

(51) Int. Cl. G06T 15/00; G06T 5/70; G06T 7/70; G06V 10/762

(52) U.S. Cl. CPC G06T 15/00; G06T 5/70; G06T 7/70; G06V 10/762

(57) ABSTRACT

A determination unit determines whether or not a current input image includes an inserted object that is not included in a real space map on the basis of the real space map and the current input image. An update processing unit executes first map update processing of updating the real space map according to current position/pose information and past position/pose information on the basis of a determination result that the current input image does not include the inserted object, and executes second map update processing different from the first map update processing, the second map update processing updating the real space map according to the current position/pose information on the basis of the determination result that the current input image includes the inserted object.

### FIELD

The present disclosure relates to an information processing apparatus, an information processing method, and a storage medium.

### BACKGROUND

Conventionally, in augmented reality (AR), virtual reality (VR), and robotics, an environment around a user or a robot is three-dimensionally updated in real time.

### CITATION LIST

### Non Patent Literature

Non Patent Literature 1: B. Curless and M. Levoy. A volumetric method for building complex models from range images. In ACM Transactions on Graphics (SIGGRAPH), 1996.
Non Patent Literature 2: Newcombe, Richard A., et al. “Kinectfusion: Real-time dense surface mapping and tracking.” ISMAR. Vol. 11. No. 2011. 2011.
Non Patent Literature 3: Lorensen, William E., and Harvey E. Cline. “Marching cubes: A high resolution 3D surface construction algorithm.” ACM siggraph computer graphics. Vol. 21. No. 4. ACM, 1987.
Non Patent Literature 4: Fehr, Marius, et al. “TSDF-based change detection for consistent long-term dense reconstruction and dynamic object discovery.” 2017 IEEE International Conference on Robotics and automation (ICRA). IEEE, 2017.
Non Patent Literature 5: Oleynikova, Helen, et al. “Voxblox: Incremental 3d euclidean signed distance fields for on-board may planning.” 2017 IEEE/RSJ International Conference on Intelligent Robots and Systems (IROS). IEEE, 2017.

### PATENT LITERATURE

Patent Literature 1: JP 2020-512646 A

### SUMMARY

### Technical Problem

However, in the conventional technology, there is room for improvement in updating the map of a real space with low delay and high accuracy when a change such as appearance of a new object in a current scene in the real space occurs.

Therefore, the present disclosure proposes an information processing apparatus, an information processing method, and a storage medium capable of updating a map with low delay and high accuracy.

### Solution to Problem

A determination unit determines whether or not a current input image includes an inserted object that is not included in a real space map on the basis of the real space map and the current input image. An update processing unit executes first map update processing of updating the real space map according to current position/pose information and past position/pose information on the basis of a determination result that the current input image does not include the inserted object, and executes second map update processing different from the first map update processing, the second map update processing updating the real space map according to the current position/pose information on the basis of the determination result that the current input image includes the inserted object.

### BRIEF DESCRIPTION OF DRAWINGS

FIG. 1 is a diagram for describing a signed distance field.

FIG. 2 is a diagram for describing a signed distance field.

FIG. 3 is a block diagram illustrating a functional configuration example of the information processing apparatus according to an embodiment.

FIG. 4 is a diagram illustrating an outline of determination processing by a determination unit.

FIG. 5 is a diagram for describing a purpose of processing of calculating a distance between a candidate region that is a cluster and an inserted object included in an insertion point cloud list.

FIG. 6 is a diagram for describing a pixel of interest and a voxel of interest.

FIG. 7 is a diagram illustrating a processing outline of update processing by an update processing unit.

FIG. 8 is a flowchart illustrating a processing procedure of real space map update processing executed by the information processing apparatus according to the embodiment.

FIG. 9 is a flowchart illustrating a processing procedure of map update processing executed by the information processing apparatus according to the embodiment.

FIG. 10 is a flowchart illustrating a processing procedure of inserted object region detection processing executed by the information processing apparatus according to the embodiment.

FIG. 11 is a block diagram illustrating an example of a hardware configuration of the information processing apparatus according to the present embodiment.

### DESCRIPTION OF EMBODIMENTS

The embodiment of the present disclosure will be described below in detail on the basis of the drawings. Note that, in each embodiment described below, the same parts are designated by the same reference numerals, and duplicate description will be omitted.

Furthermore, in this specification and the drawings, a plurality of components having substantially the same functional configuration may be distinguished by assigning the same reference numerals followed by different numbers in some cases. However, when it is unnecessary to particularly distinguish each of the plurality of components having substantially the same functional configuration, only the same reference numeral is assigned.

Furthermore, the present disclosure will be described according to the item order described below.
1. Introduction
2. Outline of the Present Disclosure
3. Functional Configuration of the Information Processing Apparatus
4. Processing Flow
5. Hardware Configuration Example
6. Conclusion

### 1. Introduction

In AR, VR, and robotics, an environment around a user or a robot is three-dimensionally reconfigured using devices such as a depth sensor, a stereo camera, and a distance measuring sensor, and it is important to perform such reconfiguration in real time.

For example, in a case where a user performs AR or VR in an indoor environment, or in a case where a robot acts within a predetermined range, the user or the robot visits the same real space many times in principle, and thus, it is possible to reuse a three-dimensional map (hereinafter, a 3D map) that has been previously reconfigured.

On the other hand, since the positions of furniture, objects, and the like arranged in the real space change every day, a difference may occur in a part of the current scene as compared with a scene that has been reconfigured previously. Accordingly, in order to compensate for this difference, a technique of updating the reconfigured 3D map in real time on the basis of information obtained by sensing the current scene with the aforementioned device is required.

As a representative method of reconfiguring a scene in real time, there is a method of integrating a multi-view depth image into a signed distance field (see, for example, Non Patent Literatures 1 and 2). These methods are currently used in various scenes because they can perform processing in real time and can extract a polygon mesh important for shielding and physical simulation (see, for example, Non Patent Literature 3).

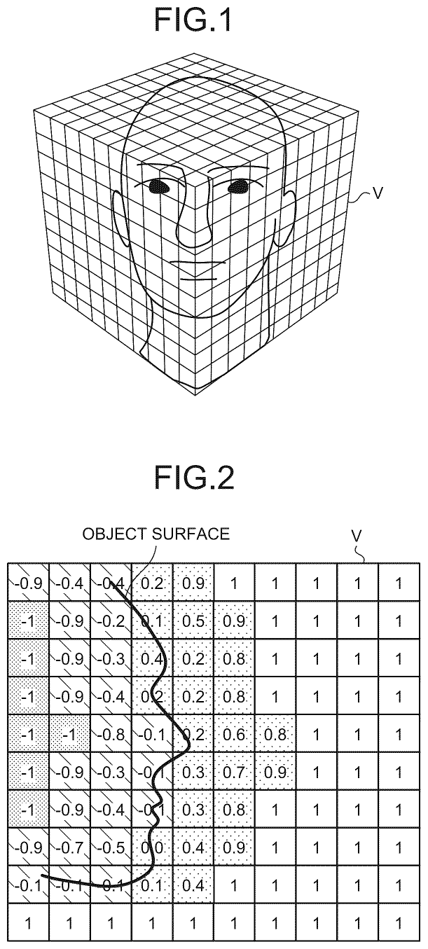

Here, the signed distance field will be described with reference to FIGS. 1 and 2. FIGS. 1 and 2 are diagrams for describing a signed distance field. FIG. 1 illustrates voxels V obtained by dividing a three-dimensional space, which is a real space, into a lattice array. The entire voxel V includes a plurality of voxels V, which are unit elements. As illustrated in FIG. 2, the signed distance field is a distance field indicated by storing a signed distance (the outside of the object is positive, the inside is negative, and the object surface is zero) to an object surface and a weight parameter indicating reliability of the signed distance in each voxel V. Then, every time the depth image and the pose of the device corresponding to the depth image are obtained from the aforementioned device, the signed distance field is sequentially updated on the basis of a temporal moving average. As described above, in Non Patent Literatures 1 and 2, the 3D map is reconfigured by integrating the multi-view depth image into the signed distance field using the moving average.

However, in the conventional technique described above, there is a problem that a delay occurs in updating the 3D map and extracting the polygon mesh in a region where there is a change from the scene at the time point when reconfiguration was performed previously to the current scene. This is because the signed distance field update method of the conventional technique is based on the moving average, and the update cannot immediately follow the change in the scene due to the slow effect caused by the characteristic of the moving average.

For such a problem, for example, a solution on the premise that a three-dimensional shape of an object newly appearing in a scene is known in advance is conceivable. This is to refer to a shape database of an object registered in advance, detect the object from the depth image, further estimate its object pose, and then update the signed distance field using shape data registered in the shape database.

However, this method requires a strong precondition that the three-dimensional shape of the object that can be inserted into the scene is known, and thus there is a problem that the update of the signed distance field is delayed or cannot be accurately updated when an object having an unknown shape appears in the scene.

Furthermore, in addition, as a document focusing on 3D scanning at different times in the same space, there is Non Patent Literature 4. Non Patent Literature 4 discloses a method of separating a room into a 3D model of a static region and a 3D model of a dynamic region using two or more 3D maps obtained by scanning the same room at different times as inputs. However, Non Patent Literature 4 aims to separate a plurality of scanned maps as inputs into a static region and a dynamic region in an offline environment, and does not update the 3D map in real time.

Furthermore, Patent Literature 1 discloses a method of performing self-localization and mapping in an environment where the position of an object changes. Since mapping is performed by matching processing with a known object database, Patent Literature 1 cannot cope with an unknown object, and in addition, a sparse feature point map is assumed as a map representation method, Patent Literature 1 is not aimed at dense 3D reconfiguration or mesh extraction.

### 2. Outline of the Present Disclosure

Therefore, the present disclosure proposes a method for solving the above-described problem occurring in the conventional technique without using the shape database of a known object. Note that, in <<2. Outline of the Present Disclosure>>, an outline of processing executed by an information processing apparatus 1 according to the embodiment will be described, and more detailed processing will be described in <<3. Functional Configuration of the Information Processing Apparatus>> and thereafter.

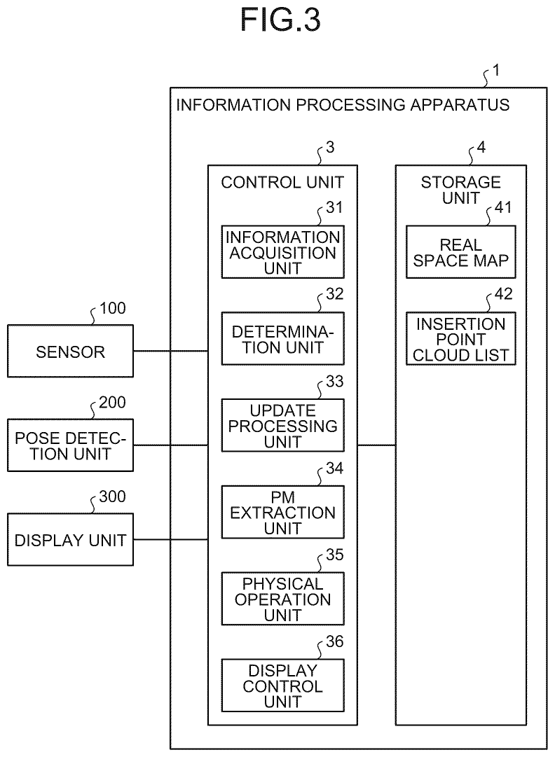

In the present disclosure, the information processing apparatus 1 (see FIG. 3) according to the embodiment determines whether or not a current input image includes an inserted object that is not included in a real space map, and performs real space map update processing according to the determination result.

For example, the information processing apparatus 1 according to the embodiment executes first map update processing of updating the real space map in accordance with current position/pose information and past position/pose information on the basis of the determination result that the current input image does not include the inserted object. The first map update processing is, for example, update processing of updating the real space map by a moving average based on the current position/pose information and the past position/pose information.

On the other hand, the information processing apparatus 1 according to the embodiment executes second map update processing of updating the real space map in accordance with the current position/pose information on the basis of the determination result that the current input image includes the inserted object. The second map update processing is update processing different from the first map update processing, and is update processing of updating the real space map on the basis of the current position/pose information without using the past position/pose information.

That is, the information processing apparatus 1 according to the embodiment executes the first map update processing on a region in which a new inserted object does not exist, and executes the second map update processing on a region in which a new inserted object exists within the current input image.

Thus, the information processing apparatus 1 performs the update processing by the moving average based on the current position/pose information and the past position/pose information with respect to the region in which the inserted object does not exist in the real space map, so that it is possible to perform the update with high accuracy while reducing noise included in the input image. Furthermore, the information processing apparatus 1 performs update processing based on the current position/pose information with respect to the region in which the inserted object exists in the real space map, so that it is possible to perform the update of immediately reflecting the newly appeared inserted object in the real space map. As described above, with the information processing apparatus 1 according to the embodiment, the real space map can be updated with low delay and high accuracy.

Hereinafter, details of the information processing apparatus 1 according to the above-described embodiment will be described.

### 3. Functional Configuration of the Information Processing Apparatus

First, a functional configuration example of the above-described information processing apparatus 1 will be described with reference to FIG. 3. FIG. 3 is a block diagram illustrating a functional configuration example of the information processing apparatus 1 according to the embodiment. As illustrated in FIG. 3, the information processing apparatus 1 according to the embodiment includes a control unit 3, a storage unit 4, a sensor 100, a pose detection unit 200, and a display unit 300. Note that, although FIG. 3 illustrates a configuration in which the sensor 100, the pose detection unit 200, and the display unit 300 are incorporated inside the information processing apparatus 1, at least one of the sensor 100, the pose detection unit 200, and the display unit 300 may be configured to be arranged outside the information processing apparatus 1 and connected to the information processing apparatus 1.

The sensor 100 acquires a depth image as an input image. The sensor 100 includes, for example, a time of flight (TOF) type distance measuring sensor, a stereo camera, and a distance measuring sensor such as light detection and ranging (LiDAR). The sensor 100 generates a depth image indicating a distance to an object (inserted object) existing in the real space and outputs the depth image to the control unit 3.

Furthermore, the sensor 100 may also acquire a captured image as an input image. The sensor 100 includes, for example, a complementary metal oxide semiconductor (CMOS) image sensor or a charge coupled device (CCD) image sensor. The sensor 100 outputs the acquired captured image to the control unit 3.

The pose detection unit 200 detects the pose of a sensor unit 21 used to acquire the input image using arbitrary odometry to acquire position/pose information. For example, a pose detection unit 22 acquires position/pose information (for example, 6 degrees of freedom (Dof)) using an IMU sensor or the like and outputs the information to the control unit 3.

The display unit 300 is a display such as a liquid crystal display (LCD), and displays information output from the control unit 3. Furthermore, the display unit 300 may have a function of displaying a three-dimensional virtual object such as AR or VR.

The storage unit 4 is achieved by, for example, a semiconductor memory element such as random access memory (RAM), read only memory (ROM), or flash memory, or a storage apparatus such as a hard disk or an optical disk. In the example illustrated in FIG. 3, the storage unit 4 stores a real space map 41, an insertion point cloud list 42, and various programs.

The real space map 41 is map information of the real space based on the input image. The real space map 41 may be three-dimensional map information or two-dimensional map information. The real space map 41 is indicated by voxels V obtained by dividing a three-dimensional space, which is a real space, into a lattice array. The entire voxel V includes a plurality of voxels V, which are unit elements. Each voxel V stores a signed distance (the outside of the object is positive, the inside is negative, and the object surface is zero) to an object surface and a weight parameter indicating reliability of the signed distance.

The insertion point cloud list 42 is list information regarding a point cloud (pixel group) of the inserted object. Specifically, the insertion point cloud list 42 is information on a point cloud of a newly detected inserted object included in the current input image and not included in the real space map 41.

Note that the information of the insertion point cloud list 42 may be configured to be included in the real space map 41. That is, a label indicating whether or not each voxel V of the real space map 41 is a region of the inserted object may be configured to be assigned.

The control unit 3 is a controller, and is implemented by, for example, a central processing unit (CPU), a micro processing unit (MPU), or the like executing various programs stored in the storage unit 4 using the RAM as a work area. Furthermore, the control unit 3 can be implemented by, for example, an integrated circuit such as an application specific integrated circuit (ASIC), a field programmable gate array (FPGA), or the like.

The control unit 3 includes an information acquisition unit 31, a determination unit 32, an update processing unit 33, a PM extraction unit 34, a physical operation unit 35, and a display control unit 36, and achieves or executes a function and an operation of information processing described below.

The information acquisition unit 31 acquires various types of information. For example, the information acquisition unit 31 reads (acquires) the real space map 41 from the storage unit 4. Furthermore, the information acquisition unit 31 acquires the current input image acquired by the sensor 100. Furthermore, the information acquisition unit 31 acquires the current position/pose information of the sensor 100 corresponding to the current input image from the pose detection unit 200.

Specifically, the information acquisition unit 31 acquires the position/pose information of the sensor 100 detected by the pose detection unit 200 when the current input image is acquired as the current position/pose information.

Furthermore, the information acquisition unit 31 acquires a past input image acquired by the sensor 100. For example, the information acquisition unit 31 buffers an input image acquired from the sensor 100 at predetermined intervals in the storage unit 4, and acquires an input image that is one or more previous frames of the current input image as a past input image. Furthermore, the information acquisition unit 31 acquires the past position/pose information of the sensor 100 corresponding to the past input image from the pose detection unit 200. Specifically, the information acquisition unit 31 acquires the position/pose information of the sensor 100 detected by the pose detection unit 200 when the past input image is acquired as the past position/pose information.

The determination unit 32 determines whether or not the current input image includes an inserted object that is not included in the real space map 41 on the basis of the real space map 41 and the current input image acquired by the information acquisition unit 31.

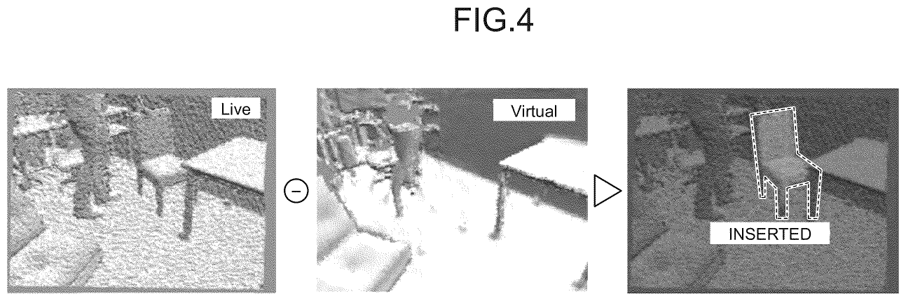

Here, a processing outline of the determination processing by the determination unit 32 will be described with reference to FIG. 4. FIG. 4 is a diagram illustrating an outline of determination processing by the determination unit 32. In FIG. 4, the image described as “Live” corresponds to the current input image. The image described as “Virtual” corresponds to a virtual input image to be described below. “Inserted” is an image indicating a residual obtained by subtracting “Virtual” from “Live”, and in the example illustrated in FIG. 4, a chair that is an inserted object newly appearing in “Live” is extracted as a residual. That is, the determination unit 32 subtracts the information of the virtual input image to be described below from the current input image, and determines the presence or absence of the region of the inserted object (the region of the chair in FIG. 4) from the residual that is a subtraction result.

First, the determination unit 32 generates a virtual input image on the basis of the current input image and the real space map 41. Specifically, the determination unit 32 generates, from the real space map 41, a virtual input image having substantially the same position/pose information as the current position/pose information of the sensor 100 corresponding to the current input image. The generation of the virtual input image includes, for example, a method using a ray marching method, a method of rendering a polygon mesh extracted from a 3D map, which is the real space map 41, using a graphics pipeline, and the like. In the present disclosure, the generated virtual input image may be regarded as a two-dimensional image (2D image) virtually generated from the 3D map, which is the real space map 41.

Subsequently, the determination unit 32 calculates a residual map using the current input image and the generated virtual input image. The residual map can be calculated by Formula (1) described below where the residual map is R (u), the current input image is D (u), and the virtual input image is D˜(u).

$$R ( u ) = \frac{D ( u ) - \tilde{D} ( u )}{\tilde{D} ( u )} \qquad ( 1 )$$

Alternatively, the residual map may be calculated by Formula (2) described below where a virtual normal image is N (u), information obtained by converting a current input image into a point cloud using an internal parameter of the sensor 100 is V (u), and information obtained by converting a virtual input image into a point cloud using an internal parameter of the sensor 100 is V˜(u). Note that the virtual normal image can be generated simultaneously when the virtual input image is generated.

$$R ( u ) = \frac{( V ( u ) - \tilde{V} ( u ) ) \cdot N ( u )}{\tilde{D} ( u )} \qquad ( 2 )$$

Next, the determination unit 32 performs spatial filtering processing on the calculated residual map. As the filtering processing, for example, opening processing combining erosion and dilation can be used. Thus, it is possible to remove noise included in the residual map caused by noise included in the current input image and the virtual input image.

Subsequently, the determination unit 32 generates a binarized image obtained by binarizing each pixel with a preset threshold in the residual map after the filtering processing. Subsequently, the determination unit 32 clusters the binarized images on the basis of connected components. The cluster extracted by this clustering is a set in which pixels having the same value in binarization are connected, and becomes a candidate region of the inserted object.

Subsequently, the determination unit 32 determines whether or not the candidate region, which is the extracted cluster, is truly a region of the inserted object.

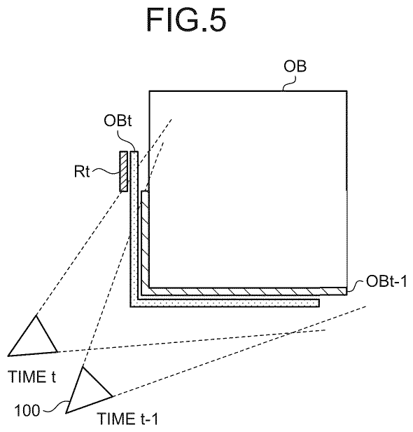

First, the determination unit 32 calculates a distance between the candidate region, which is the extracted cluster, and the inserted object included in the insertion point cloud list 42. Note that the purpose of calculating such a distance will be described below with reference to FIG. 5.

First, the determination unit 32 converts the depth of each pixel constituting the cluster into a point cloud using the internal parameter of the sensor 100. Subsequently, the determination unit 32 refers to the insertion point cloud list 42 stored in the storage unit 4 and calculates distance d between each point cloud Pᵢ={pᵢ}ᵢ included in the insertion point cloud list 42 and point cloud Pⱼ={pⱼ}ⱼ of the cluster. As the distance d, for example, a Euclidean distance as in Formula (3) described below can be used.

$$d = {min}_{( i , j )} \vert {p}_{i} - {p}_{j} \vert \qquad ( 3 )$$

Alternatively, as the distance d, a Mahalanobis distance considering the distribution of the point cloud of the cluster as in Formula (4) described below may be used. Note that Σⱼ in Formula (4) described below is a variance-covariance matrix of the point cloud Pⱼ of the cluster, and P-j is a centroid of the point cloud Pⱼ of the cluster.

$$d = {min}_{i} \sqrt{{( {p}_{i} - {\overline{p}}_{j} )}^{T} {\sum }_{j} ( {p}_{i} - {\overline{p}}_{j} )} \qquad ( 4 )$$

Then, for a cluster whose distance d is less than a preset threshold, the determination unit 32 determines that such a cluster is the same as an inserted object detected in the past, more specifically, determines that an inserted object detected in the past is a point cloud detected from a different angle (or the same angle). That is, when the distance d is less than the preset threshold, the determination unit 32 determines that the cluster is the point cloud of the inserted object already registered in the insertion point cloud list 42 and is not the inserted object newly detected in the current input image. Then, the determination unit 32 updates the information of the inserted object already registered in the insertion point cloud list 42 on the basis of such a cluster.

On the other hand, for a cluster whose distance d is equal to or greater than the preset threshold, the determination unit 32 determines that the cluster is either an inserted object newly detected in the current input image or an outlier caused by noise of the residual map.

Then, for a cluster whose distance d is equal to or greater than the preset threshold, in a case where the number of pixels of the cluster is less than a preset threshold, the determination unit 32 determines that the cluster is the aforementioned outlier and excludes the cluster from the region of the inserted object.

On the other hand, for a cluster whose distance d is equal to or greater than the preset threshold, in a case where the number of pixels of the cluster is equal to or greater than the preset threshold, the determination unit 32 determines that the cluster is a region of the inserted object newly detected in the current input image, and registers the cluster as a region of the new inserted object in the insertion point cloud list 42.

That is, in a case where, for the extracted cluster, the distance is equal to or greater than the threshold and the number of pixels of the cluster is equal to or greater than the threshold, the determination unit 32 determines that the current input image includes an inserted object not included in the real space map 41.

Furthermore, in a case where, for all the extracted clusters, the distance is less than the threshold or the number of pixels of the cluster is less than the threshold, the determination unit 32 determines that the current input image does not include an inserted object not included in the real space map 41.

Next, the purpose of the processing of calculating the distance between the candidate region that is the extracted cluster and the inserted object included in the insertion point cloud list 42 will be described with reference to FIG. 5.

FIG. 5 is a diagram for describing a purpose of processing of calculating the distance between the candidate region that is a cluster and the inserted object included in the insertion point cloud list 42. In other words, such processing is processing of buffering the region of the previously detected inserted object in the insertion point cloud list 42 and comparing the region with the currently detected candidate region. In FIG. 5, a case where a predetermined inserted object OB is detected by the sensor 100 over two frames at time t-1 and time t will be considered.

In such a case, at time t-1, a region OBt-1 of the inserted object OB is detected, and the real space map 41 is updated. Next, at time t, a region OBt is detected, but since a zero intersection plane is generated for the portion of the region OBt-1 in the region OBt by the update of the real space map 41, at time t, the value of the aforementioned residual map becomes equal to or greater than the threshold only in a region Rt.

As described above, in a case where the inserted object OB is measured in consecutive frames, since much of the regions OBt-1 and OBt measured in both frames overlap, it is considered that the region Rt in which the value of the residual map increases is smaller than the region OBt-1.

For this reason, if buffering is not performed in the insertion point cloud list 42, that is, in a case where whether the cluster is a region of the inserted object is determined only by the number of pixels of the cluster, it is difficult to distinguish whether the region Rt is an outlier caused by noise of the residual map or a region of the inserted object that has already been partially measured.

This is because, in a case where the threshold of the number of pixels of the cluster is increased, it is erroneously determined that the number of pixels of the region Rt is less than the threshold and is an outlier, and on the other hand, in a case where the threshold is decreased, there is a high possibility that another cluster generated by noise is erroneously determined as a region of the inserted object in contrast to the case where the target cluster can be determined as a region of the inserted object.

On the other hand, as described above, in a case where buffering is performed in the insertion point cloud list 42, by calculating the distance d between the insertion point cloud list 42 and the point cloud of the cluster, it can be determined that the region Rt illustrated in FIG. 5 is a part of the region of the inserted object OB that has already been measured.

That is, a small cluster (region Rt illustrated in FIG. 5) generated by measuring the already measured inserted object OB from a slightly different angle can be determined to be unfailingly a region of the inserted object OB, and at the same time, other small clusters that are outliers can be excluded by the pixel quantity threshold processing.

In this manner, the accuracy of detection of the region of the inserted object can be enhanced by buffering the region of the previously detected inserted object in the insertion point cloud list 42 and comparing with the currently detected cluster.

Note that, in the case of the example illustrated in FIG. 5, the region of the inserted object OB registered in the insertion point cloud list 42 is updated to a region obtained by combining the region OBt-1 and the region Rt.

The update processing unit 33 performs different map update processing according to the determination result of the inserted object by the determination unit 32. Specifically, the update processing unit 33 executes the first map update processing on the basis of the determination result by the determination unit 32 that the current input image does not include the new inserted object, and executes the second map update processing on the basis of the determination result that the current input image includes the new inserted object.

In the first map update processing, the update processing of updating the real space map 41 according to the current position/pose information and the past position/pose information is executed. Furthermore, the second map update processing is update processing of updating the real space map 41 according to the current position/pose information without using the past position/pose information.

First, the update processing unit 33 performs ray casting from the center of the sensor 100 for each pixel (pixel of interest) of the current input image, and acquires a voxel (voxel of interest) with which the ray interests.

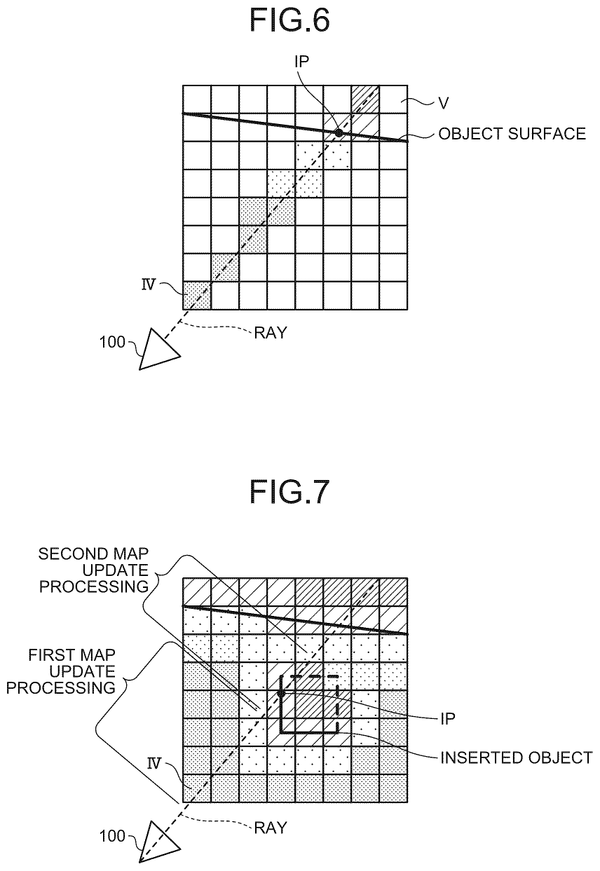

FIG. 6 is a diagram for describing a pixel of interest and a voxel of interest. As illustrated in FIG. 6, when a point (depth) corresponding to the object surface is obtained from the input image based on the current position/pose information of the sensor 100, such a point is determined as a pixel of interest IP. Then, a line passing through the pixel of interest IP and the sensor 100 is set as a ray, and a voxel with which the ray intersects is determined as a voxel of interest IV. In the example illustrated in FIG. 6, colored voxels are all voxels of interest IV, and the lighter the color, the closer to the pixel of interest IP.

Then, as illustrated in FIG. 7, the update processing unit 33 performs the first map update processing or the second map update processing using the pixel of interest IP and the voxel of interest IV. FIG. 7 is a diagram illustrating a processing outline of update processing by the update processing unit 33. The example illustrated in FIG. 7 illustrates an example in which a new inserted object is inserted.

As illustrated in FIG. 7, in a case where a new inserted object is inserted into the current input image, the sensor 100 detects the object surface of the inserted object as a depth, the detected depth becomes the pixel of interest IP, and the voxels of interest IV are extracted according to the pixel of interest IP. Then, the update processing unit 33 performs the second map update processing on the voxel of interest IV corresponding to the inserted object among the extracted voxels of interest IV, and performs the first map update processing on the voxels of interest IV not corresponding to the inserted object.

Specifically, the update processing unit 33 performs two pieces of determination processing using the pixel of interest and the voxel of interest, and performs the first map update processing or the second map update processing according to the determination results of the two pieces of determination processing.

As the first determination processing, the update processing unit 33 determines whether or not the pixel of interest is a region of the inserted object. Specifically, the update processing unit 33 determines whether or not the pixel of interest is a pixel included in the region of the inserted object newly registered in the insertion point cloud list 42. Furthermore, as the second determination processing, the update processing unit 33 determines whether or not the distance between the voxel of interest and the measurement point (pixel of interest IP) of the input image of interest is less than a preset threshold.

In a case where any one of these two pieces of determination processing does not satisfy the condition, it is considered that the space occupied by the voxel of interest has not changed significantly from the time point when the real space map 41 has been previously generated (updated), and thus the update processing unit 33 executes the first map update processing. That is, in a case where the pixel of interest is not a region of the inserted object, or in a case where the distance between the voxel of interest and the measurement point of the input image of interest is equal to or greater than the threshold, the update processing unit 33 updates the signed distance and the weight parameter in the voxel in the real space map 41 by executing the first map update processing using Formulae (5) and (6) described below, which are moving averages.

$${D}_{t} ( v ) = \frac{{W}_{t - 1} ( v ) {D}_{t - 1} ( v ) + {w}_{i} ( v , u ) {d}_{t} ( v , u )}{{W}_{t - 1} ( v ) + {w}_{i} ( v , u )} \qquad ( 5 )$$

$${W}_{t} ( v ) = {W}_{t - 1} ( v ) + {w}_{t} ( v , u ) \qquad ( 6 )$$

In aforementioned Formulae (5) and (6), Dₜ₋₁(v) and Wₜ₋₁(v) are the signed distance and the weight parameter before the update, and dₜ(v,u) and wₜ(v,u) are the signed distance and the weight parameter calculated on the basis of the current input image and the current position/pose information.

On the other hand, in a case where the conditions of both two pieces of determination processing are satisfied, it is considered that a change has occurred in the space occupied by the voxel of interest as a result of insertion of a new object as compared with the time point when the real space map 41 has been previously generated (updated), and thus, the update processing unit 33 executes the second map update processing. That is, in a case where the pixel of interest is a region of the inserted object and in a case where the distance between the voxel of interest and the measurement point of the input image of interest is less than the threshold, the update processing unit 33 updates the signed distance and the weight parameter in the voxel in the real space map 41 by executing the second map update processing using Formulae (7) and (8) described below.

$${D}_{t} ( v ) = {d}_{t} ( v , u ) \qquad ( 7 )$$

$${W}_{t} ( v ) = {w}_{t} ( v , u ) \qquad ( 8 )$$

Formulae (7) and (8) mean to immediately reflect the input image regarding the current scene acquired from the sensor 100 in the real space map 41. In this manner, it is possible to achieve both the noise reduction effect of the first map update processing and the immediacy of the second map update processing by explicitly determining whether the voxel of interest is the space occupied by the inserted object and adaptively switching the update method. That is, low-delay and high-accuracy map update can be achieved.

The PM extraction unit 34 extracts a polygon mesh for each inserted object from the real space map 41 updated by the update processing unit 33. Specifically, the PM extraction unit 34 extracts a voxel having a signed distance of zero in the real space map 41 for each inserted object, and extracts a polygon mesh for each inserted object on the basis of the extracted voxel.

The physical operation unit 35 performs various operations regarding operations of AR, VR, a robot, and the like on the basis of the polygon mesh extracted by the PM extraction unit 34, and reflects the operation result in AR, VR, a robot, and the like.

The display control unit 36 performs an operation of display regarding AR or VR on the basis of the polygon mesh extracted by the PM extraction unit 34 and reflects the operation result in the display unit 300.

### 4. Processing Flow

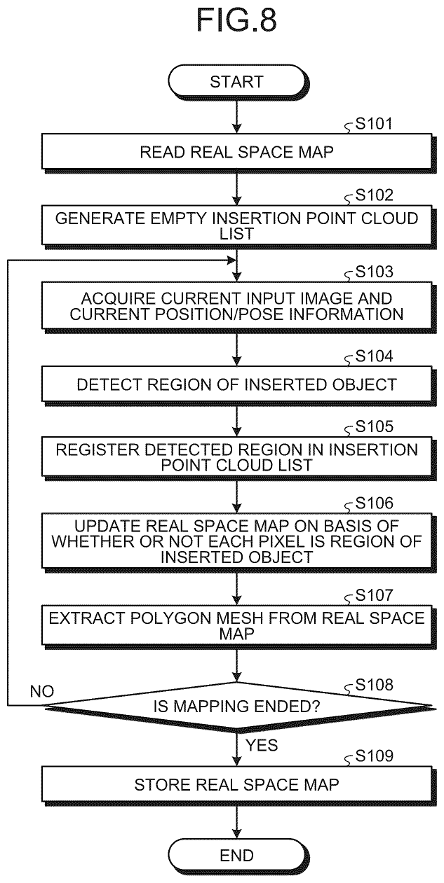

Next, a processing procedure of real space map update processing executed by the information processing apparatus 1 according to the embodiment will be described with reference to FIG. 8. FIG. 8 is a flowchart illustrating a processing procedure of real space map update processing executed by the information processing apparatus 1 according to the embodiment.

As illustrated in FIG. 8, the control unit 3 reads the real space map 41 stored in the storage unit 4 (Step S101).

Subsequently, the control unit 3 generates an empty insertion point cloud list 42 related to the point cloud of the inserted object corresponding to the real space map 41 in the storage unit 4 (Step S102).

Subsequently, the control unit 3 acquires the current input image and the current position/pose information of the sensor 100 corresponding to the current input image (Step S103).

Subsequently, the control unit 3 detects a region of a new inserted object included in the current input image on the basis of the current input image, the current position/pose information, and the real space map 41 (Step S104).

Subsequently, the control unit 3 registers a point cloud corresponding to the detected region of the inserted object in the insertion point cloud list 42 (Step S105).

Subsequently, the control unit 3 updates the real space map 41 on the basis of whether or not each pixel of the current input image is a pixel included in the region of the inserted object (Step S106).

Subsequently, the control unit 3 extracts a polygon mesh from the updated real space map 41 (Step S107).

Subsequently, the control unit 3 determines whether or not the mapping has been ended (Step S108), and when the mapping has been ended (Step S108: Yes), the control unit 3 stores the real space map 41 in the storage unit 4 (Step S109), and ends the processing. On the other hand, in a case where the mapping has not been ended (Step S108: No), the control unit 3 returns to Step S103.

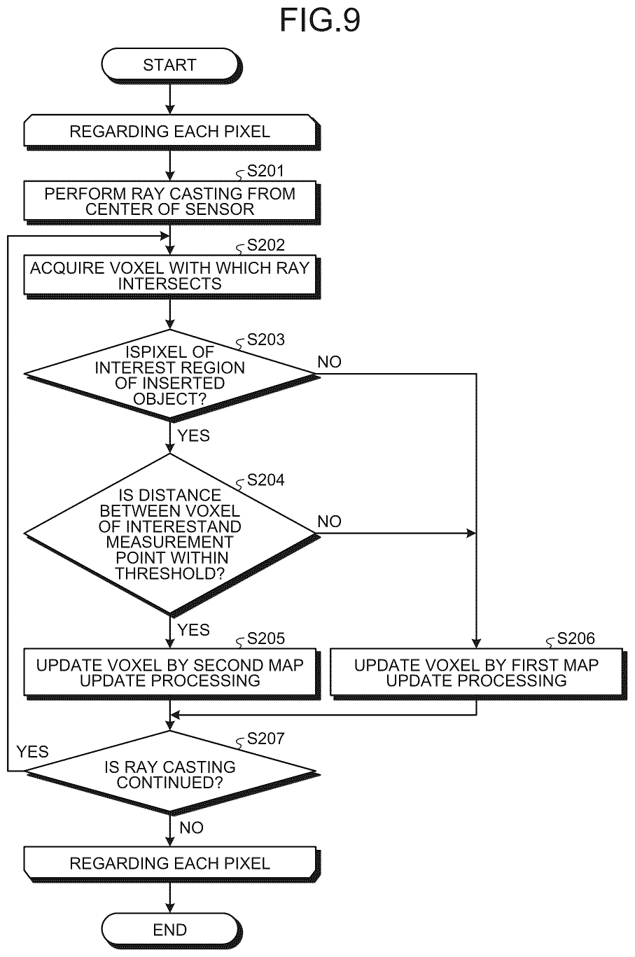

Next, a processing procedure of map update processing executed by the information processing apparatus 1 according to the embodiment will be described with reference to FIG. 9. FIG. 9 is a flowchart illustrating a processing procedure of map update processing executed by the information processing apparatus 1 according to the embodiment.

First, as illustrated in FIG. 9, the control unit 3 performs ray casting from the center of the sensor 100 for each pixel of the input image (Step S201).

Subsequently, the control unit 3 acquires a voxel with which the ray intersects (Step S202).

Subsequently, the control unit 3 determines whether or not the pixel of interest is a region of the inserted object (Step S203).

In a case where the pixel of interest is a region of the inserted object (Step S203: Yes), the control unit 3 determines whether or not the distance between the voxel of interest and the measurement point is within the threshold (Step S204).

When the distance between the voxel of interest and the measurement point is within the threshold (Step S204: Yes), the control unit 3 updates the voxel by the second map update processing (Step S205).

On the other hand, when the pixel of interest is not a region of the inserted object (Step S203: No), or when the distance between the voxel of interest and the measurement point is not within the threshold (Step S204: No), the control unit 3 updates the voxel by the first map update processing (Step S206).

Subsequently, after the first map update processing or the second map update processing, the control unit 3 determines whether or not to continue ray casting (Step S207), and in a case where the ray casting is continued (Step S207: Yes), the processing returns to Step S202.

On the other hand, in a case where the ray casting is not continued (Step S207: No), and the map update processing for each pixel is completed, the control unit 3 ends the processing. Note that, in a case where the map update processing for each pixel is not completed, the control unit 3 repeatedly executes Steps S201 to S207 until the map update processing is completed.

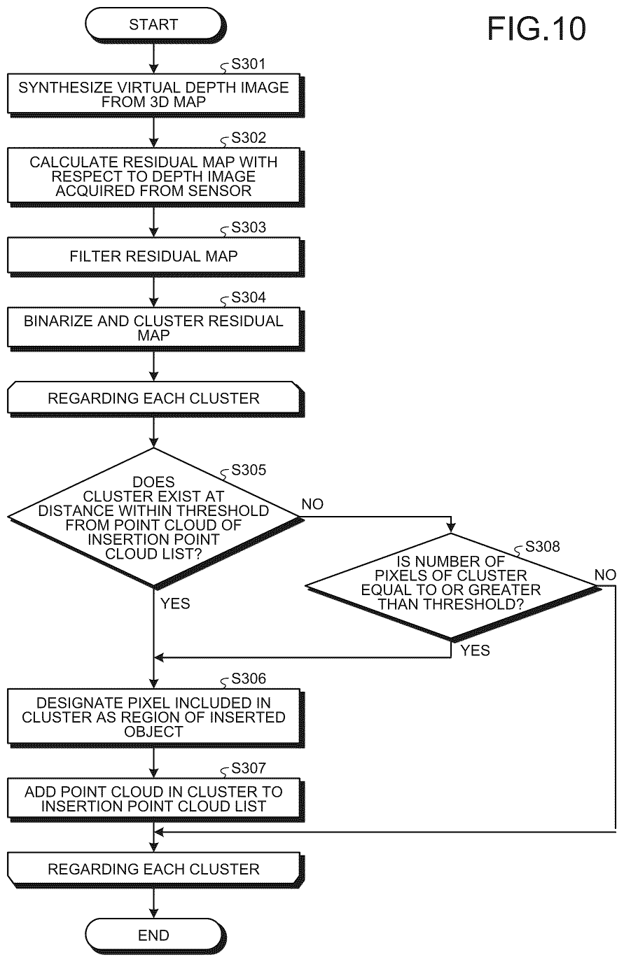

Next, a processing procedure of inserted object region detection processing executed by the information processing apparatus 1 according to the embodiment will be described with reference to FIG. 10. FIG. 10 is a flowchart illustrating a processing procedure of inserted object region detection processing executed by the information processing apparatus 1 according to the embodiment.

As illustrated in FIG. 10, first, the control unit 3 synthesizes a virtual depth image (past input image) from the real space map 41 (Step S301).

Subsequently, the control unit 3 calculates a residual map between the depth image (current input image) acquired from the sensor and the past input image (Step S302).

Subsequently, the control unit 3 performs filtering on the residual map (Step S303).

Subsequently, the control unit 3 binarizes and clusters the residual map after filtering (Step S304).

Subsequently, the control unit 3 determines, for each cluster, whether or not the cluster exists at a distance within a threshold from the point cloud registered in the insertion point cloud list 42 (Step S305).

In a case where the cluster exists at a distance within the threshold from the point cloud registered in the insertion point cloud list 42 (Step S305: Yes), the control unit 3 designates a pixel included in the cluster as a region of the inserted object (Step S306).

Subsequently, the control unit 3 adds the point cloud in the cluster to the insertion point cloud list 42 (Step S307), and ends the processing in a case where the aforementioned processing is completed for each cluster. Note that, in a case where the aforementioned processing is not completed for each cluster, the control unit 3 repeatedly executes Steps S305 to S308 until the processing is completed.

Note that, in Step S305, in a case where the cluster does not exist at a distance within the threshold from the point cloud registered in the insertion point cloud list 42 (Step S305: No), the control unit 3 determines whether or not the number of pixels of the cluster is equal to or greater than the threshold (Step S308).

In a case where the number of pixels of the cluster is equal to or greater than the threshold (Step S308: Yes), the control unit 3 proceeds to Step S306. That is, it is designated as a region of the new inserted object.

On the other hand, when the number of pixels of the cluster is less than the threshold (Step S308: No), the control unit 3 detects the cluster as noise and proceeds to the processing of the next cluster.

### 5. Hardware Configuration Example

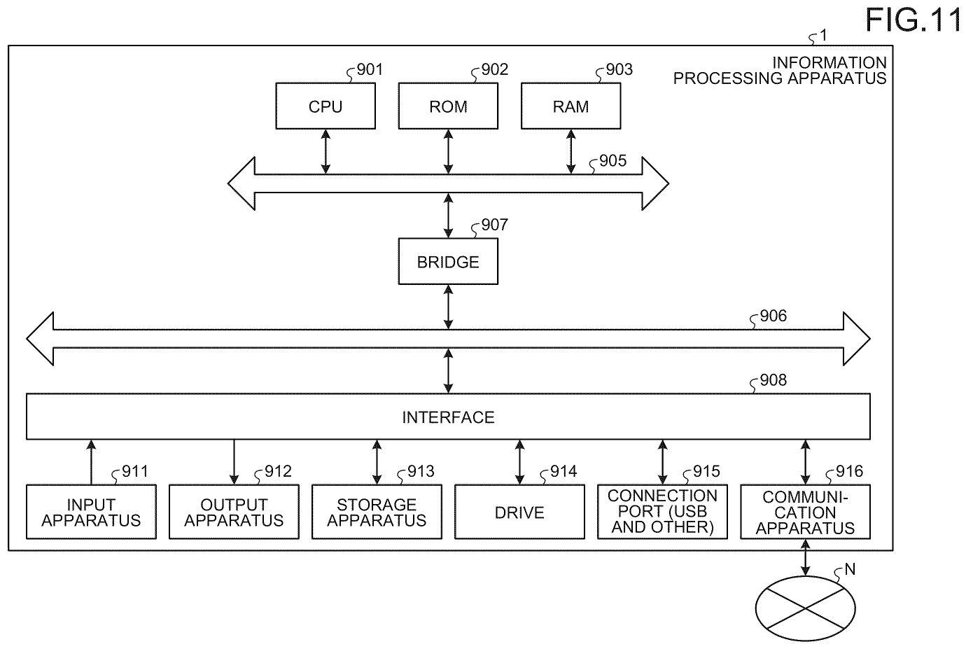

Next, an example of a hardware configuration of the information processing apparatus 1 and the like according to the present embodiment will be described with reference to FIG. 11. FIG. 11 is a block diagram illustrating an example of a hardware configuration of the information processing apparatus 1 according to the present embodiment.

As illustrated in FIG. 11, the information processing apparatus 1 includes a central processing unit (CPU) 901, read only memory (ROM) 902, random access memory (RAM) 903, a host bus 905, a bridge 907, an external bus 906, an interface 908, an input apparatus 911, an output apparatus 912, a storage apparatus 913, a drive 914, a connection port 915, and a communication apparatus 916. The information processing apparatus 1 may include a processing circuit such as an electric circuit, a DSP, or an ASIC instead of or in addition to the CPU 901.

The CPU 901 functions as an operation processing apparatus and a control apparatus, and controls the overall operation in the information processing apparatus 1 according to various programs. Furthermore, the CPU 901 may be a microprocessor. The ROM 902 stores a program, operation parameters, and the like used by the CPU 901. The RAM 903 temporarily stores the programs used in the execution of the CPU 901, the parameters that appropriately vary in this execution, and the like. For example, the CPU 901 may execute the functions of the information acquisition unit 31, the determination unit 32, the update processing unit 33, the PM extraction unit 34, the physical operation unit 35, and the display control unit 36.

The CPU 901, the ROM 902, and the RAM 903 are mutually connected by the host bus 905 including a CPU bus and the like. The host bus 905 is connected to the external bus 906 such as a peripheral component interconnect/interface (PCI) bus via the bridge 907. Note that the host bus 905, the bridge 907, and the external bus 906 are not necessarily separately configured, and their functions may be mounted on one bus.

The input apparatus 911 is, for example, an apparatus to which information is input by a user, such as a mouse, a keyboard, a touch panel, a button, a microphone, a switch, or a lever. Alternatively, the input apparatus 911 may be a remote control apparatus using infrared rays or other radio waves, or may be external connection equipment such as a mobile phone or a PDA corresponding to the operation of the information processing apparatus 1. Further, the input apparatus 911 may include, for example, an input control circuit that generates an input signal on the basis of information input by the user using the aforementioned input means.

The output apparatus 912 is an apparatus capable of visually or auditorily notifying the user of information. The output apparatus 912 may be, for example, a display apparatus such as a cathode ray tube (CRT) display apparatus, a liquid crystal display apparatus, a plasma display apparatus, an electro luminescence (EL) display apparatus, a laser projector, a light emitting diode (LED) projector, or a lamp, or may be a sound output apparatus such as a speaker or a headphone.

The output apparatus 912 may output, for example, results obtained by various types of processing by the information processing apparatus 1. Specifically, the output apparatus 912 may visually display the results obtained by various types of processing by the information processing apparatus 1 in various formats such as text, image, table, or graph. Alternatively, the output apparatus 912 may convert an audio signal such as sound data or acoustic data into an analog signal and auditorily output the analog signal. The input apparatus 911 and the output apparatus 912 may execute a function of an interface, for example.

The storage apparatus 913 is a data storage apparatus formed as an example of the storage unit 4 of the information processing apparatus 1. The storage apparatus 913 may be achieved by, for example, a magnetic storage device such as a hard disk drive (HDD), a semiconductor storage device, an optical storage device, a magneto-optical storage device, or the like. For example, the storage apparatus 913 may include a storage medium, a recording apparatus for recording data on the storage medium, a reading apparatus for reading data from the storage medium, and a deletion apparatus for deleting data recorded on the storage medium, or the like. The storage apparatus 913 may store programs executed by the CPU 901, various data, various data acquired from the outside, and the like. For example, the storage apparatus 913 may execute a function of storing the real space map 41 and the insertion point cloud list 42.

The drive 914 is a reader/writer for a storage medium, and is built in or externally attached to the information processing apparatus 1. The drive 914 reads information recorded in a removable storage medium such as a mounted magnetic disk, optical disk, magneto-optical disk, or semiconductor memory, and outputs the information to the RAM 903. Furthermore, the drive 914 can also write information to the removable storage medium.

The connection port 915 is an interface connected to external equipment. The connection port 915 is a connection port capable of data transmission to external equipment, and may be, for example, a universal serial bus (USB).

The communication apparatus 916 is, for example, an interface formed of a communication device for connecting to a network N. The communication apparatus 916 may be, for example, a communication card for a wired or wireless local area network (LAN), long term evolution (LTE), Bluetooth (registered trademark), or a wireless USB (WUSB). Furthermore, the communication apparatus 916 may be a router for optical communication, a router for asymmetric digital subscriber line (ADSL), a modem for various types of communication, or the like. For example, the communication apparatus 916 can transmit and receive signals and the like to and from the Internet or another communication equipment in accordance with a predetermined protocol such as TCP/IP.

Note that the network N is a wired or wireless information transmission path. For example, the network N may include the Internet, a public network such as a telephone network or a satellite communication network, various local area networks (LANs) including Ethernet (registered trademark), a wide area network (WAN), or the like. Furthermore, the network N may include a dedicated line network such as an Internet protocol-virtual private network (IP-VPN).

Note that it is also possible to create a computer program for causing hardware such as the CPU, the ROM, and the RAM built in the information processing apparatus 1 to exhibit functions equivalent to those of the configurations of the information processing apparatus 1 according to the present embodiment described above. Furthermore, a storage medium storing the computer program can also be provided.

Furthermore, among the pieces of processing described in the aforementioned embodiment, all or some of the pieces of processing described as being performed automatically can be performed manually, or all or some of the pieces of processing described as being performed manually can be performed automatically by a known method. In addition, the processing procedures, the specific names, and the information including various data and parameters indicated in the aforementioned document and drawings can be arbitrarily changed unless otherwise specified. For example, the various types of information illustrated in each drawing are not limited to the illustrated information.

Furthermore, each component of each apparatus illustrated in the drawings is functionally conceptual, and is not necessarily physically configured as illustrated in the drawings. That is, a specific form of distribution and integration of apparatuses is not limited to those illustrated in the drawings, and all or a part thereof can be functionally or physically distributed and integrated in an arbitrary unit according to various loads, usage situations, and the like.

Furthermore, the above-described embodiment can be appropriately combined within an area not contradicting processing contents. Furthermore, the order of each step illustrated in the flowchart and sequence diagram of the above-described embodiment can be changed as appropriate.

### 6. Conclusion

As described above, according to an embodiment of the present disclosure, the information processing apparatus 1 includes the information acquisition unit 31, the determination unit 32, and the update processing unit 33. The information acquisition unit 31 acquires the real space map 41 corresponding to the real space stored in the storage medium (storage unit 4), the current input image and the past input image indicating the real space acquired by the sensor 100, the current position/pose information of the sensor 100 corresponding to the current input image, and the past position/pose information of the sensor 100 corresponding to the past input image. The determination unit 32 determines whether or not the current input image includes an inserted object that is not included in the real space map 41 on the basis of the real space map 41 and the current input image. The update processing unit 33 executes the first map update processing of updating the real space map 41 according to the current position/pose information and the past position/pose information on the basis of a determination result that the current input image does not include the inserted object, and executes the second map update processing different from the first map update processing, the second map update processing updating the real space map 41 according to the current position/pose information on the basis of the determination result that the current input image includes the inserted object.

Thus, the real space map 41 can be updated with low delay and high accuracy.

Furthermore, the update processing unit 33 executes the second map update processing on the voxel of interest IV corresponding to the pixel of interest IP in a case where the pixel of interest IP in the current input image is included in the region of the inserted object on the basis of the determination result that the current input image includes the inserted object, and executes the first map update processing on the voxel of interest IV corresponding to the pixel of interest IP in a case where the pixel of interest IP is not included in the region of the inserted object.

Thus, the low-delay map update can be achieved by executing the second map update processing on the region of the inserted object within the current input image, and the high-accuracy map update excluding noise can be achieved by executing the first map update processing on the region other than the inserted object.

The update processing unit 33, in a case where the pixel of interest IP in the current input image is included in the region of the inserted object, executes the second map update processing on the voxel of interest IV when a distance between the pixel of interest IP and the voxel of interest IV is less than a predetermined threshold, and executes the first map update processing on the voxel of interest IV when the distance between the pixel of interest IP and the voxel of interest IV is equal to or greater than the predetermined threshold.

Thus, even in a case where the pixel of interest IP and the voxel of interest IV are away from each other, that is, in a case where there is a low possibility that the pixel of interest IP and the voxel of interest IV are the same inserted object, the map update accuracy can be increased.

The determination unit 32 generates a virtual input image from the real space map 41 according to the current position/pose information, and determines whether or not the current input image includes the inserted object by using the residual map calculated on the basis of the current input image and the virtual input image.

Thus, it is possible to determine with high accuracy whether the current input image includes the inserted object.

The determination unit 32 determines whether or not the current input image includes the inserted object by using the residual map on which the filtering processing for removing noise included in the residual map has been performed.

Thus, since it is possible to remove noise included in the residual map caused by noise included in the current input image and the virtual input image, it is possible to increase determination accuracy using the residual map.

The determination unit 32 generates a binarized image obtained by binarizing each pixel in the residual map, and determines whether or not the current input image includes the inserted object on the basis of the region of the cluster obtained by clustering connected components in the binarized image.

Thus, the region of the inserted object included in the current input image can be extracted with high accuracy.

The determination unit 32, in a case where the distance between the region of the cluster extracted this time and the region of the cluster extracted last time is less than a predetermined threshold, determines that the region of the cluster is a region of the inserted object.

Thus, it is possible to determine that a small cluster generated by measuring the already measured inserted object with the sensor 100 from a slightly different angle is unfailingly a region of the inserted object OB.

The determination unit 32, in a case where the number of pixels in the region of the cluster is equal to or greater than a predetermined threshold, determines that the region of the cluster is a region of the inserted object.

Thus, a region having a certain number or more of pixels (a certain size or more) can be extracted as a region of the inserted object with high accuracy, and an outlier caused by noise of the residual map can be excluded from the region of the inserted object with high accuracy.

The generated virtual input image is a two-dimensional image having substantially the same position/pose information as the current position/pose information.

Thus, it is possible to obtain a highly accurate residual map calculation result in the calculation of the residual map in a subsequent stage.

In the real space map 41, voxels V including a signed distance and a weight indicating the reliability of the signed distance are arranged. The first map update processing is update processing in which the moving average of the signed distance and the weight calculated on the basis of the current input image corresponding to the current position/pose information and the past input image corresponding to the past position/pose information is set as an updated value, and the second map update processing is update processing in which the signed distance and the weight calculated on the basis of the current input image corresponding to the current position/pose information is set as an updated value.

Thus, it is possible to immediately reflect the newly appeared inserted object in the real space map 41 while reducing the noise included in the current input image.

Although each embodiment of the present disclosure has been described above, the technical scope of the present disclosure is not limited to the above-described embodiment as it is, and various changes can be made without departing from the gist of the present disclosure. Furthermore, components of different embodiments and modifications may be appropriately combined.

Furthermore, the effects of each embodiment described in the present specification are merely examples and are not limitative, and there may be other effects.

Note that the present technology can also have the following configurations.

(1)

An information processing apparatus comprising:
an information acquisition unit that acquires a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination unit that determines whether or not the current input image includes an inserted object not included in the real space map on a basis of the real space map and the current input image; and
an update processing unit that executes
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.
   (2)

The information processing apparatus according to the above-described (1), wherein
the update processing unit
executes the second map update processing on a voxel of interest corresponding to a pixel of interest in a case where the pixel of interest in the current input image is included in a region of the inserted object on a basis of the determination result that the current input image includes the inserted object, and
executes the first map update processing on the voxel of interest corresponding to the pixel of interest in a case where the pixel of interest is not included in the region of the inserted object.
   (3)

The information processing apparatus according to the above-described (2), wherein
the update processing unit,
in a case where the pixel of interest in the current input image is included in the region of the inserted object, executes the second map update processing on the voxel of interest when a distance between the pixel of interest and the voxel of interest is less than a predetermined threshold, and
executes the first map update processing on the voxel of interest when the distance between the pixel of interest and the voxel of interest is equal to or greater than the predetermined threshold.
   (4)

The information processing apparatus according to the above-described (1) to (3), wherein
the determination unit
generates a virtual input image from the real space map according to the current position/pose information, and determines whether or not the current input image includes the inserted object by using a residual map calculated on a basis of the current input image and the virtual input image.
   (5)

The information processing apparatus according to the above-described (4), wherein
the determination unit
determines whether or not the current input image includes the inserted object by using the residual map on which filtering processing for removing noise included in the residual map has been performed.
   (6)

The information processing apparatus according to the above-described (4) or (5), wherein
the determination unit
generates a binarized image obtained by binarizing each pixel in the residual map, and determines whether or not the current input image includes the inserted object on a basis of a region of a cluster obtained by clustering connected components in the binarized image.
   (7)

The information processing apparatus according to the above-described (6), wherein
the determination unit,
in a case where a distance between the region of the cluster extracted this time and the region of the cluster extracted last time is less than a predetermined threshold, determines that the region of the cluster is a region of the inserted object.
   (8)

The information processing apparatus according to the above-described (6) or (7), wherein
the determination unit,
in a case where a number of pixels in the region of the cluster is equal to or greater than a predetermined threshold, determines that the region of the cluster is a region of the inserted object.
   (9)

The information processing apparatus according to the above-described (4) to (8), wherein the generated virtual input image is a two-dimensional image having substantially same position/pose information as the current position/pose information.

(10)

The information processing apparatus according to the above-described (1) to (9), wherein
in the real space map,
voxels including a signed distance and a weight indicating reliability of the signed distance are arranged,
the first map update processing is
update processing in which a moving average of the signed distance and the weight calculated on a basis of the current input image corresponding to the current position/pose information and the past input image corresponding to the past position/pose information is set as an updated value, and
the second map update processing is
update processing in which the signed distance and the weight calculated on a basis of the current input image corresponding to the current position/pose information is set as an updated value.
   (11)

An information processing method executed by a computer, the method comprising:
an information acquisition process of acquiring a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination process of determining whether or not the current input image includes an inserted object not included in the real space map on a basis of the real space map and the current input image; and
an update processing process of executing
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.
   (12)

A storage medium storing a program for causing a computer to function as:
an information acquisition unit that acquires a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination unit that determines whether or not the current input image includes an inserted object not included in the real space map on a basis of the real space map and the current input image; and
an update processing unit that executes
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.

### REFERENCE SIGNS LIST

1 INFORMATION PROCESSING APPARATUS
3 CONTROL UNIT
4 STORAGE UNIT
21 SENSOR UNIT
22 POSE DETECTION UNIT
31 INFORMATION ACQUISITION UNIT
32 DETERMINATION UNIT
33 UPDATE PROCESSING UNIT
34 PM EXTRACTION UNIT
35 PHYSICAL OPERATION UNIT
36 DISPLAY CONTROL UNIT
41 REAL SPACE MAP
42 INSERTION POINT CLOUD LIST
100 SENSOR
200 POSE DETECTION UNIT
300 DISPLAY UNIT
IP PIXEL OF INTEREST
IV VOXEL OF INTEREST
OB INSERTED OBJECT
V VOXEL

1. An information processing apparatus comprising:
an information acquisition unit that acquires a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination unit that determines whether or not the current input image includes an inserted object not included in the real space map on a basis of the real space map and the current input image; and
an update processing unit that executes
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.

2. The information processing apparatus according to claim 1, wherein
the update processing unit
executes the second map update processing on a voxel of interest corresponding to a pixel of interest in a case where the pixel of interest in the current input image is included in a region of the inserted object on a basis of the determination result that the current input image includes the inserted object, and
executes the first map update processing on the voxel of interest corresponding to the pixel of interest in a case where the pixel of interest is not included in the region of the inserted object.

3. The information processing apparatus according to claim 2, wherein
the update processing unit,
in a case where the pixel of interest in the current input image is included in the region of the inserted object, executes the second map update processing on the voxel of interest when a distance between the pixel of interest and the voxel of interest is less than a predetermined threshold, and
executes the first map update processing on the voxel of interest when the distance between the pixel of interest and the voxel of interest is equal to or greater than the predetermined threshold.

4. The information processing apparatus according to claim 1, wherein
the determination unit
generates a virtual input image from the real space map according to the current position/pose information, and determines whether or not the current input image includes the inserted object by using a residual map calculated on a basis of the current input image and the virtual input image.

5. The information processing apparatus according to claim 4, wherein
the determination unit
determines whether or not the current input image includes the inserted object by using the residual map on which filtering processing for removing noise included in the residual map has been performed.

6. The information processing apparatus according to claim 4, wherein
the determination unit
generates a binarized image obtained by binarizing each pixel in the residual map, and determines whether or not the current input image includes the inserted object on a basis of a region of a cluster obtained by clustering connected components in the binarized image.

7. The information processing apparatus according to claim 6, wherein
the determination unit,
in a case where a distance between the region of the cluster extracted this time and the region of the cluster extracted last time is less than a predetermined threshold, determines that the region of the cluster is a region of the inserted object.

8. The information processing apparatus according to claim 6, wherein
the determination unit,
in a case where a number of pixels in the region of the cluster is equal to or greater than a predetermined threshold, determines that the region of the cluster is a region of the inserted object.

9. The information processing apparatus according to claim 4, wherein the generated virtual input image is a two-dimensional image having substantially same position/pose information as the current position/pose information.

10. The information processing apparatus according to claim 1, wherein
in the real space map,
voxels including a signed distance and a weight indicating reliability of the signed distance are arranged,
the first map update processing is
update processing in which a moving average of the signed distance and the weight calculated on a basis of the current input image corresponding to the current position/pose information and the past input image corresponding to the past position/pose information is set as an updated value, and
the second map update processing is
update processing in which the signed distance and the weight calculated on a basis of the current input image corresponding to the current position/pose information is set as an updated value.

11. An information processing method executed by a computer, the method comprising:
an information acquisition process of acquiring a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination process of determining whether or not the current input image includes an inserted object not included in the real space map on a basis of the real space map and the current input image; and
an update processing process of executing
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.

12. A storage medium storing a program for causing a computer to function as:
an information acquisition unit that acquires a real space map corresponding to a real space stored in a storage medium, a current input image and a past input image indicating the real space acquired by a sensor, current position/pose information of the sensor corresponding to the current input image, and past position/pose information of the sensor corresponding to the past input image;
a determination unit that determines whether or not the current input image includes an inserted object not included in the real space map on a basis of the real space map and the current input image; and
an update processing unit that executes
first map update processing of updating the real space map according to the current position/pose information and the past position/pose information on a basis of a determination result that the current input image does not include the inserted object, and
second map update processing different from the first map update processing, the second map update processing updating the real space map according to the current position/pose information on a basis of a determination result that the current input image includes the inserted object.
